(19) United States
(12) Patent Application Publication
(10) Pub. No.: US 2002/0091598 A1
(43) Pub. Date: Jul. 11, 2002

(54) Method for web-based electronic process for initiation of, engagement in, and conduct of attorney-client relationship

(76) Inventor: Peter Farkas, Washington, DC (US)

Correspondence Address: John P. Sumner, OPTREON, 530 Race Street, San Jose, CA, 95126, US

(21) Appl. No.: 09/758,630

(22) Filed: Jan. 10, 2001

(51) Int. Cl. G06F 17/60

(52) U.S. Cl. 705/30; 713/200; 707/9

(57) ABSTRACT

A method and system for initiating and engaging in a business relationship through an internet website between a prospective client and a service professional. The method comprises contacting the internet website of the service professional, providing certain predetermined information about the client to the internet website, comparing the information to an existing client database of the service professional, and determining whether a conflict exists between the information provided and the existing client database.

The present application is a continuation of pending provisional patent application Serial No. 60/174,909, filed on Jan. 10, 2000, entitled “Method for Web-Based Electronic Process for Initiation of Engagement in, and Conduct of Attorney-Client Relationship”.

### BACKGROUND OF THE INVENTION

1. Field of the Invention

This invention relates generally to business method of initiating a relationship between a professional and a potential client over the internet and, more particularly, it relates to a business method of utilizing the internet for initiating communications between a professional and a potential client, processing the engagement of the professional to establish the relationship, and assigning and completing the client's assigned work.

2. Description of the Prior Art

In order to initiate a relationship between a professional and a potential client, the professional must oftentimes conduct a conflict check to determine whether the professional will have a conflict of interest in representing the potential client. A potential client desires to determine whether a professional is able to represent the potential client without a conflict of interest. This is especially true for attorneys and law firms.

Today, a potential client must actually contact the attorney or law firm via the telephone or in-person in order to initiate a conflict of interest check. Telephonic and in-person conflict of interest checking is a very time consuming method for both the professional and the potential client. Such a conflict check system is described in the Horwitz, et al, U.S. Pat. No. 5,774,866. The Horwitz, et al patent describes a computer system for checks for conflicts associated with proposed new matters.

Many law firms and other providers of legal and professional services use Internet websites as electronic firm brochures describing the firm's services, attorneys, locations, and policies. Unfortunately, these websites offer little interaction for a potential client to initiate legal services or conduct conflict of interest checks via the website without actually discussing his or her situation.

Accordingly, there exists a need for a method for web-based electronic process for initiation of, engagement in, and conduct of attorney-client relationship which allows a potential client to initiate a professional relationship. Additionally, a need exists for a method for web-based electronic process for initiation of, engagement in, and conduct of attorney-client relationship which allows a potential client to conduct a conflict of interest check via the internet. Furthermore, there exists a need for a method for web-based electronic process for initiation of, engagement in, and conduct of attorney-client relationship which assigns and completes the work for the potential client via the internet.

The object of the method of the present invention is to create an interactive website that expands the capabilities of professional service providers' websites to include:

a. Initiation of communications between a potential or prospective client and an attorney professional potentially leading to an attorney-client business relationship;

b. Processing the engagement of the attorney or law firm by the prospective client to establish the attorney-client relationship; and/or

c. Using the attorney or law firm's web site in assigning and completing the legal work for which the attorney or law firm was engaged.

### SUMMARY

The present invention is a method for initiating and engaging in a business relationship through an internet website between a prospective client and a service professional. The method comprises contacting the internet website of the service professional, providing certain predetermined information about the client to the internet website, comparing the information to an existing client database of the service professional, and determining whether a conflict exists between the information provided and the existing client database.

The present invention further includes a system for initiating and engaging in a business relationship through an internet website between a prospective client and a service professional with the service professional having an internet website and an existing client database accessible through the website. The system comprises information receiving means for receiving certain predetermined information about the client, comparing means for comparing the received information to the existing client database of the service professional, and determining means for determining whether a conflict exists between the information provided and the existing client database.

### BRIEF DESCRIPTION OF THE DRAWINGS

Features and advantages of the present invention will become apparent to those skilled in the art from the following description with reference to the drawings, in which:

FIG. 1 is a flow chart illustrating the method for web-based electronic process for initiation of, engagement in, and conduct of attorney-client relationship, in accordance with the present invention.

### DETAILED DESCRIPTION OF THE PREFERRED EMBODIMENTS

It should be noted that the business method of the present invention, as described herein and hereafter, discuss the professional as being an attorney, law firm, or other legal service providing entity. It should be noted that the present invention is not limited to the context of legal services but can include accounting firms, consulting firms, architectural firms, and any other association of professionals. The business method of the present invention especially applies to the engagement of professional services in which an initial screening process is required before the professional agrees to serve the potential client. The initial screening process includes, but not limited to, conflict of interest considerations, other business considerations, etc.

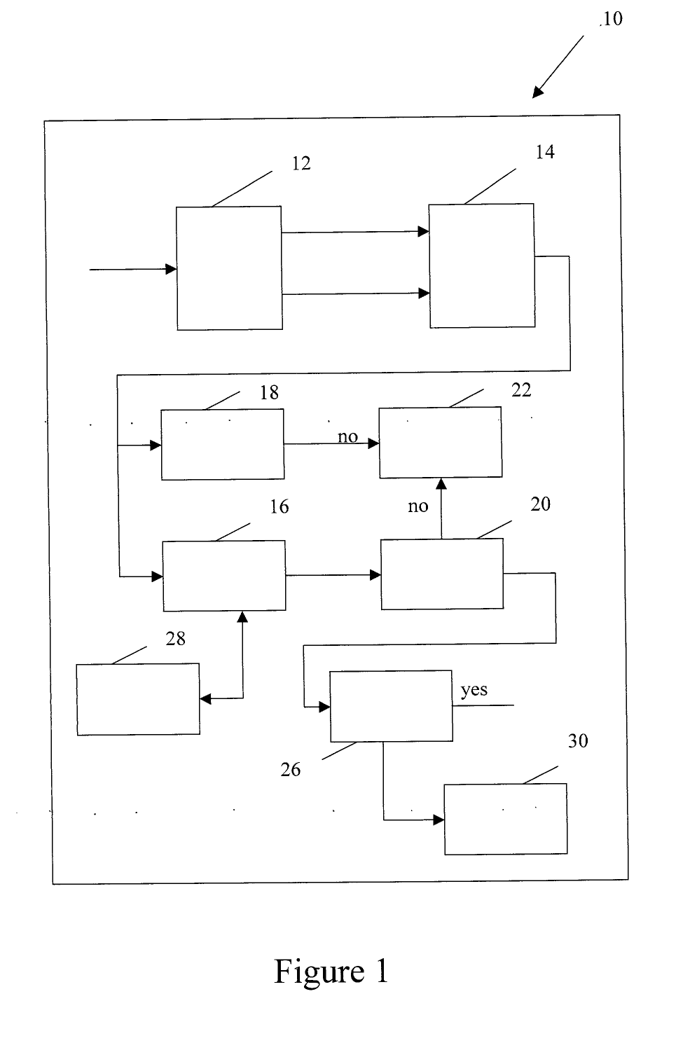

As illustrated in FIG. 1, the business method and system, as indicated generally at 10, of the present invention uses a website to initiate an attorney-client relationship. The website of the present invention can be the proprietary website of the individual attorney, of a law firm, a group of law firms, a bar associate pre-paid legal services plan, other insurer that provides reimbursement for legal services, or any other institution that offers legal services in the broadest sense of the word (hereinafter referred to as “website operators”). The website of the present invention can also link the website to other websites.

First, the method and system 10 of the present invention allows the prospective client of a legal or other professional services to perform an on-line, real time conflict check to determine whether one or more of the one or more attorneys, firms or legal services provides named or depicted on the website is available to represent the potential client from the perspective of the conflict of interest rules applicable to the website operator or prevailing in its jurisdiction. The conflict check can be set to allow the potential client to remain anonymous to the attorney, law firm or other website operator or may be set to disclose some or all the information provided by the prospective client to initiate the conflict check, based on the balance of the anticipated privacy concerns of the prospective client pool and the marketing information requirements and other promotional considerations of the attorney, law firm or other website operator.

The conflict check is initiated by the prospective client's completion of a questionnaire 12 or the like on the website and submission to the website operator of the data field identifying the prospective client, the adverse parties, and the type of legal work that is the object of the prospective engagement. The specifics of the initial conflict data field can vary depending on the needs of the attorney, law firm, or other website operator. Entry of the information into the data field can be accomplished by keyboard, mouse, voice, screen-based, or a combination of such input modes.

Once the prospective client has submitted the completed questionnaire 12, the information provided in the conflict check can be manually or electronically processed by the website operator by human memory, hard copy client list, client data base 14, or can be electronically processed by a third party provider of conflict check data base. In one preferred embodiment of the present invention, the conflict check information submitted by the prospective client will be electronically processed by the computer server of the website operator on residing or off-site software accessing the operator's database. In another preferred embodiment of the present invention, the client conflict check information submitted by the prospective client would flow through the website of the attorney law firm or other website operator to the server of a third party conflict check services provider.

In any event, the system operating the website would be configured to allow the prospective client to seamlessly obtain an initial conflict clearance within a stated period of time. That period of time is preferably within approximately one (1) minute or two (2) minutes, or however long the website operator determines that prospective clients for its offering of legal services is willing to wait and is preferable within the time the link between the prospective client's terminal and the website's server can be comfortably maintained. Alternatively, the website operator can provide the answer on conflict clearance by return e-mail, voice telephone call, or other means of communications.

The conflict check can be provided to the prospective client free of charge or for a reasonable fee. Reasons for charging the prospective client a fee for a conflict check include the passing through of third party conflict check service charges, to cover internal costs of conflict checks, to create profitable revenues, or simply to discourage excessive submissions of conflict checks by marginally interested potential clients. Any fees charged for a conflict check may be electronically charged in the various modes offered by on-line retailers of goods and services, such as via credit card, debit card, etc.

Once the conflict check has been completed, the prospective client can be advised visually or by voice, either prior to its submission of the conflict check information or with the return of the conflict clearance determination that initial clearance determination is provisional, subject to further exchanges of information, subject to business considerations, and does not represent an agreement to provide the legal services sought. The prospective client can also be advised that the prospective client can cease using the web-based electronic engagement process at any time and contact a specific person or department by telephone, e-mail or other means in order to proceed with the engagement process by some other agreed upon means, including by telephone, or a face-to-face meeting. Preferred modes of proceeding are one way or two-way web based or telephonic, fixed or wireless, video conferencing and open web-based chat-room, or other two-way real-time direct e-mail link.

In a preferred embodiment, the initial determination that there is “no conflict” or potential conflict of interest in the representation of the prospective client can be provided by a message transmitted through a page on the website activated by the clearance message. The indication that there is no conflict may also be made by a prerecorded or live video of a designated individual representing the website operator. Another preferred mode is to transmit indication of conflict clearance by e-mail to the prospective client or its designee.

One of the results of the conflict check can be an existing or potential conflict of interest which precludes the prospective representation by the website operator or its affiliates of the potential client. Such a determination can be provided by the same types of messages described for initial determinations of conflict clearance. In the alternative, the message concerning the results of the conflict check will result in the opening of or in the authorization of later access to one of several page on the web operator's website.

If the conflict check results in a “no conflict” determination, the message communicating that determination will open or allow access to an information request page 16 on the website with additional, more detailed requests for information. The information sought can be tailored to the specific nature of the legal specialty, sub-specialty or groups of practice areas for which the engagement is contemplated.

If the conflict check results in a “conflict exists” determination, the message communicating that determination will open or allow access to a page 18 on the website that allows the communication of the conflict check information previously prepared by the potential client and submitted to the website operator to one or more alternative providers of the services sought by the client. Such communication can be by access to one or more website operators 22 of such alternative providers. This retransmission page may include filters by among other things, multiple-choice pop-up screens of geographical, size, and other parameters of preference of the potential client in alternative providers.

In one preferred embodiment, such alternative provider(s) will have agreements with the first website operator for reciprocation of referrals, placement on the list of potential alternatives, referral fees and other fee sharing arrangements, professional courtesies and/or in kind service to be provided to the first website operator by the second website operator, to the extent such arrangements are permitted by the applicable rules of ethics and professional conduct. If the second website results in a “no conflict” determination, the second website would proceed to the same stage of the engagement process as provided by the “no conflict” determination by the first website operator. If the second website operator also makes a “conflict exists” determination, the potential client may be provided to means to access yet further service providers until the client obtains a “no conflict” determination.

After a “no conflict” determination and after a determination by the website operator that no other circumstances exist to decline the prospective engagement, the website operator, on the basis of the original conflict check information previously provided by the potential client or based upon a second submission of more detailed information and/triggered by a request from the potential client on a web page 20 or by e-mail can disclose its fee information to the potential client. The request for fee information may be pre-screened by the potential client for preferred fee arrangements such as hourly fees, flat fees capped fees, percentage fees, contingency fees, and hybrids of such fee arrangements. In addition the proposed client fee request may include expectation of other fees and out of pocket expenses. The fee arrangement may include the potential client's proposal for retainer amount of periodic payments. The potential client may also be afforded the choice of either electronic or personal fee proposal.

At this stage, the potential client may also be requested to authorize the website operator or other service provider to charge the potential client's designated account for the fees and expenses upon the reaching of agreement as to the financial terms of the engagements as described below.

The responsive fee may be electronically recalled from the database serving the website operator or calculated by or for the website operator, in either event based on the parameters of the matter and representation provided in the initial conflict check information submission, any subsequent information submissions and by the client preferences for fee arrangements. The website operator or service provider can choose to ignore or modify certain client preferences and state which ones and why. They exceed the website operator or fee provider's preset parameters.

The potential client can accept the fee proposal by communicating its acceptance by any of the means electronic and traditional communications previously discussed. The preferred method of such communication would be an immediate on-line electronic response. The proposal can also state a deadline by which it will expire if not accepted. In the preferred method, acceptance by the potential client within the deadline commits the website operator or other service provider to perform the services in question and will trigger an engagement letter from the website operator or other service provider, in electronic or hard copy form or both. This engagement letter 26 will vary in accordance with the client, service and fee arrangement parameters.

If the potential client likes the fee information but does not wish to proceed on-line, it may elect to change to alternative communication 30, including direct telephone call to a designated representative of the website operator or e-mail such designated person that the representative of the client wishes to receive a call from an attorney or other representative of the website operator.

The method 10 of this invention may also provide for counter-proposals 28 on fees, preferably by the potential client by electronic means which, if accepted by the website operator or other service provider commits the potential client to the website operator or other service provider.

In the event the potential client and the professional provider do not reach an engagement agreement after a number of potential offers and counter-offers, the failure to reach agreement would present the potential client with a web page explaining the completion of negotiations and offering to submit the conflict clearance information to one or more of the alternative service providers described above. The website operator may preset the number of rounds of fee proposals and counter-proposals it will entertain, and provide notice to the potential client at the beginning of the proposal process, or leave the number of rounds available to ad hoc determination by human intervention.

The process for the conflict clearance process with one or more alternative service providers would, after conflicts have been cleared and the determination has been made that no other circumstances exist to decline the engagement would provide the alternative service providers with the negotiation history with the first website operator or other service provider. The successful engagement of such alternative service providers would again be subject to the agreements described above.

Alternatively to serial one-on-one conflict clearance and fee negotiations with the website operator or other service provider, or one-on-one conflict clearance and fee negotiations followed by multiple clearances and fee negotiations, the method of this invention could begin by or change after a one-on-one round to multiple conflict clearance and an unlimited or limited participant open or closed fee proposal and counterproposal on-line bidding process. Such unlimited or limited, open or closed bidding process would be subject to variations on the type of agreements between the spoke service providers and the hub website operator or among the first website operator and hubless spoke alternative service providers.

Third, upon completion of the engagement letter and payment, electronically or otherwise, of any retainer provided under the engagement letter, the client and service provider may resume the current prior art modes of lawyer client, or other professional to client relationship. However, optionally, the client and the professional may under take a web-based electronic lawyer-client or other professional to client relationship that includes one or more of the following features. The features that can be appropriate can vary with the types of services, areas of specialty and sub-specialty client type and size involved. Thus, in the legal profession, the combination of features that can function efficiently in the corporate initial public offering practice may not be the same as might work in patent prosecution, and the combination of features that may function efficiently in patent prosecution may not be the ideal in complex civil litigation. Such variations also exist in other professions based on similar factors.

One feature of a web-based attorney client relationship is based on the recognition that some or all of the attorney's files are the client's files and should be accessible to the client at any time. Therefore, by agreement with the client and with security protections in place, some or all the client files may be electronically stored on designated client accessible websites.

Another feature of a web-based attorney client relationship is based on the recognition that the longer it takes for billing invoices to arrive at the client, the longer it takes for the client to pay. Such web-based billing for professional services has already begun, but not in combination with the other features of the invention.

Yet another feature of a web-based attorney client relationship is based on the recognition that the client may wish to monitor the fees for work in progress more frequently than the billing cycle. Therefore, service providers may offer clients real time access to billing records by secured web access.

A further feature of a web-based attorney-client relationship may include client-driven or service-provider-driven out-sourcing of individual tasks, groups of tasks and projects in certain cases. This can be achieved by using elements of the conflict clearance process and the fee proposal process, adjusted to the specific needs of the circumstances to achieve additional efficiencies.

The processes of the invention are scaleable to the size of the individual attorney, law firm or other service provider's practice. Thus, for an individual attorney or a small firm, the invention or claimed portions of the invention may simply involve a software program to provide conflict clearance and fee proposals on an existing website and linking it to in-house or third-party conflict clearance database managers. For larger law firms, other service providers and for hub and spoke systems of website operators and service providers it may mean specialized large scale computing required for unlimited open bidding procedures.

While the invention has been described with reference to the exemplary preferred embodiments thereof those skilled in the art will be able to make various modifications to the described embodiments of the invention without departing from the true spirit and scope of the invention.

I claim:

1. A method for initiating and engaging in a business relationship through an internet website between a prospective client and a service professional, the method comprising:
contacting the internet website of the service professional;
providing certain predetermined information about the client to the internet website;
comparing the information to an existing client database of the service professional; and
determining whether a conflict exists between the information provided and the existing client database.

2. The method of claim 1 wherein a conflict exists between the information provided and the existing client database, and further comprising:
providing at least one alternate service professional.

3. The method of claim 2, and further comprising:
selecting an alternate service professional; and
submitting the information to the selected alternate service professional.

4. The method of claim 1 wherein a “no conflict” exists between the information provided and the existing client database, and further comprising:
requesting additional information from the prospective client concerning the nature of services requested.

5. The method of claim 4, and further comprising:
providing specific billing information to the prospective client selected from the group consisting of hourly rates, flat fee amounts, billing periods, and retainer information.

6. The method of claim 5, and further comprising:
allowing a prospective client to negotiate the billing information with the service professional.

7. The method of claim 6 wherein negotiations between the prospective client and the service professional are successful, and further comprising:
the prospective client becoming a client; and
allowing the client to access invoice records of the client.

8. The method of claim 6 wherein negotiations between the prospective client and the service professional are unsuccessful, and further comprising:
providing at least one alternate service professional.

9. The method of claim 8, and further comprising:
selecting an alternate service professional; and
submitting the information to the selected alternate service professional.

10. The method of claim 6 wherein negotiations between the prospective client and the service professional are unsuccessful, and further comprising:
authorizing the service professional to charge an account of the prospective client for a predetermined amount.

11. The method of claim 1, and further comprising:
providing alternative contact information selected from the group consisting of telephone number, facsimile number, and e-mail address.

12. The method of claim 1, and further comprising:
providing anonymity to the prospective client.

13. A system for initiating and engaging in a business relationship through an internet website between a prospective client and a service professional, the service professional having an internet website and an existing client database accessible through the website, the system comprising:
information receiving means for receiving certain predetermined information about the client;
comparing means for comparing the received information to the existing client database of the service professional; and
determining means for determining whether a conflict exists between the information provided and the existing client database.

14. The system of claim 13 wherein a conflict exists between the information provided and the existing client database and further wherein the internet website provides at least one alternate service professional.

15. The system of claim 14 wherein the alternate service professional is selected by the prospective client and the information is provided to the selected alternate service professional.

16. The system of claim 13 wherein a “no conflict” exists between the information provided and the existing client database and further wherein the prospective client provides additional information concerning the nature of services requested.

17. The system of claim 16 wherein specific billing information selected from the group consisting of hourly rates, flat fee amounts, billing periods, and retainer information is provided to the prospective client.

18. The system of claim 17 wherein the prospective client negotiates the billing information with the service professional.

19. The system of claim 18 wherein the service professional charges an account of the prospective client for a predetermined amount.

20. The system of claim 19 wherein alternative contact information selected from the group consisting of telephone number, facsimile number, and e-mail address is provided to the prospective client.
